(19) United States
(12) Patent Application Publication
(10) Pub. No.: US 2005/0170850 A1
(43) Pub. Date: Aug. 4, 2005

(54) Methods and apparatuses for selectively disabling functionality of a device

(76) Inventors: Eric Edwards, San Jose, CA (US); Clay Fisher, San Diego, CA (US); Neal Manowitz, Montebello, NY (US); Robert Saton, San Diego, CA (US); Brian Beaver, San Francisco, CA (US)

Correspondence Address: Valley Oak Law, 5655 Silver Creek Valley Road, #106, San Jose, CA, 95138, US

(21) Appl. No.: 10/771,901

(22) Filed: Feb. 4, 2004

(51) Int. Cl. H04M 3/00

(52) U.S. Cl. 455/456.4; 455/420; 455/414.1

(57) ABSTRACT

In one embodiment, the methods and apparatuses for selectively disabling functionality of a device detect a device; detect a device type of the device; and transmit a signal to the device for selectively disabling a function of the device based on the device type.

### FIELD OF THE INVENTION

The present invention relates generally to disabling devices and, more particularly, to selectively disabling functionality of devices.

### BACKGROUND

There has been a proliferation of portable electronic devices utilized by users. These portable electronic devices include pages, cellular phones, digital cameras, video cameras, and audio players. These portable electronic devices are typically carried with the user and provide the user with the convenience of having these devices nearby. For example, a cellular phone or pager carried with the user offers the user to be in communication with others while having the freedom to travel outside the home or office.

In many circumstances, these portable electronic devices are capable of being carried and operated in public places such as airplanes, trains, restaurants, hospitals, and movie theaters. While these portable electronic devices provide the user with many conveniences, operation of these electronic devices in public locations can inconvenience others. For example, a cellular phone conversation by a patron in a restaurant can disturb other nearby diners. In another example, an audible noise emitted from a portable audio device, a cellular phone, or a pager can prevent other patrons within a movie theater from enjoying the movie.

In some circumstances, use of portable electronic devices in sensitive locations can be life threatening. For example, operation of electronic devices while an airplane departs or arrives can interfere with sensitive airplane navigation systems. In another example, operation of portable electronic device in an emergency room can interfere with sensitive medical tools.

### SUMMARY

In one embodiment, the methods and apparatuses for selectively disabling functionality of a device detect a device; detect a device type of the device; and transmit a signal to the device for selectively disabling a function of the device based on the device type.

### BRIEF DESCRIPTION OF THE DRAWINGS

The accompanying drawings, which are incorporated in and constitute a part of this specification, illustrate and explain one embodiment of the methods and apparatuses for selectively disabling functionality of a device. In the drawings,

FIG. 1 is a diagram illustrating an environment within which the methods and apparatuses for selectively disabling functionality of a device are implemented;

FIG. 2 is a simplified block diagram illustrating one embodiment in which the methods and apparatuses for selectively disabling functionality of a device are implemented;

FIG. 3 is a simplified block diagram illustrating a system, consistent with one embodiment of the methods and apparatuses for selectively disabling functionality of a device;

FIG. 4 is an exemplary record for use with the methods and apparatuses for selectively disabling functionality of a device;

FIG. 5 is a flow diagram consistent with one embodiment of the methods and apparatuses for selectively disabling functionality of a device;

FIG. 6 is a flow diagram consistent with one embodiment of the methods and apparatuses for selectively disabling functionality of a device; and

FIG. 7 is a flow diagram consistent with one embodiment of the methods and apparatuses for selectively disabling functionality of a device.

### DETAILED DESCRIPTION

The following detailed description of the methods and apparatuses for selectively disabling functionality of a device refers to the accompanying drawings. The detailed description is not intended to limit the methods and apparatuses for selectively disabling functionality of a device. Instead, the scope of the methods and apparatuses for selectively disabling functionality of a device is defined by the appended claims and equivalents. Those skilled in the art will recognize that many other implementations are possible, consistent with the present invention.

References to “electronic device” and “device” include a device such as a video camera, a still picture camera, a cellular phone, a personal digital assistant, an audio player, and an image capturing device.

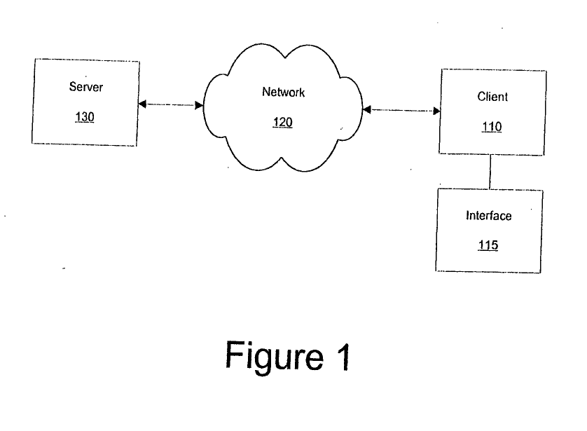

FIG. 1 is a diagram illustrating an environment within which the methods and apparatuses for selectively disabling functionality of a device are implemented. The environment includes an electronic device 110 (e.g., a computing platform configured to act as a client device, such as a computer, a personal digital assistant, a digital camera, a video camera), a user interface 115, a network 120 (e.g., a local area network, a home network, the Internet), and a server 130 (e.g., a computing platform configured to act as a server).

In one embodiment, one or more user interface 115 components are made integral with the electronic device 110 (e.g., keypad and video display screen input and output interfaces in the same housing as personal digital assistant electronics (e.g., as in a Clie® manufactured by Sony Corporation). In other embodiments, one or more user interface 115 components (e.g., a keyboard, a pointing device (mouse, trackball, etc.), a microphone, a speaker, a display, a camera are physically separate from, and are conventionally coupled to, electronic device 110. The user utilizes interface 115 to access and control content and applications stored in electronic device 110, server 130, or a remote storage device (not shown) coupled via network 120.

In accordance with the invention, embodiments of selectively disabling functionality of a device below are executed by an electronic processor in electronic device 110, in server 130, or by processors in electronic device 110 and in server 130 acting together. Server 130 is illustrated in FIG. 1 as being a single computing platform, but in other instances are two or more interconnected computing platforms that act as a server.

The methods and apparatuses for selectively disabling functionality of a device are shown in the context of exemplary embodiments of applications in which a function of a device is selectively disabled based on the location of the device and the device type of the device. In one embodiment, a signal disabling the device is transmitted to the electronic device 110 through the network 120.

In one embodiment, the methods and apparatuses for selectively disabling functionality of a device utilizes a record associated with a profile. In one embodiment, the profile includes details relating to selectively disabling a function of a device. In one instance, the profile indicates an area covered, a device type includes, a function disabled, any devices exempt from the profile, and any requested payment in exchange to restore the function.

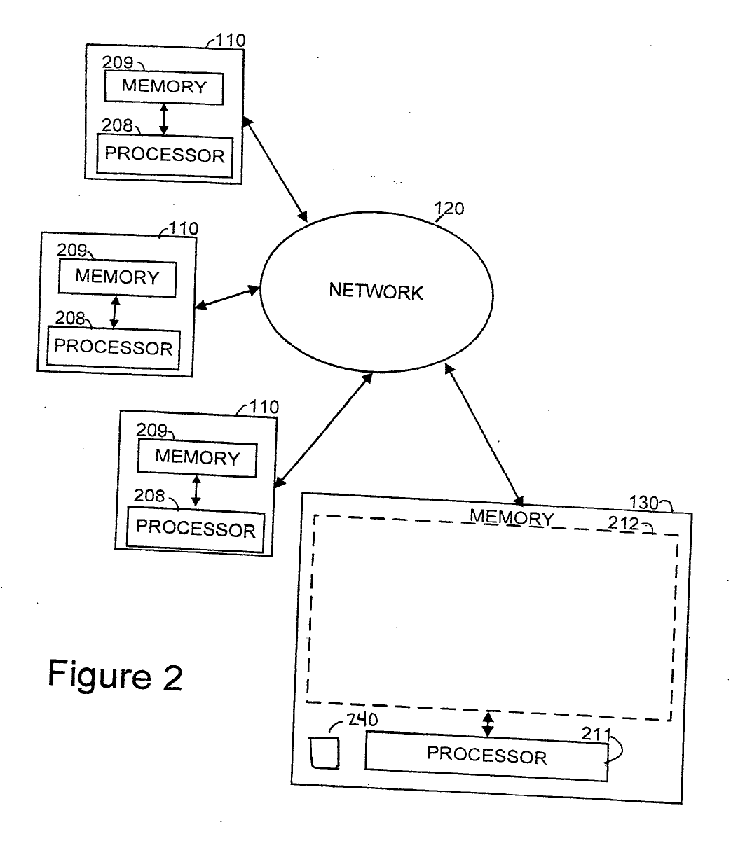

FIG. 2 is a simplified diagram illustrating an exemplary architecture in which the methods and apparatuses for selectively disabling functionality of a device are implemented. The exemplary architecture includes a plurality of electronic devices 110, a server device 130, and a network 120 connecting electronic devices 110 to server 130 and each electronic device 110 to each other. The plurality of electronic devices 110 are each configured to include a computer-readable medium 209, such as random access memory, coupled to an electronic processor 208. Processor 208 executes program instructions stored in the computer-readable medium 209. A unique user operates each electronic device 110 via an interface 115 as described with reference to FIG. 1.

Server device 130 includes a processor 211 coupled to a computer-readable medium 212. In one embodiment, the server device 130 is coupled to one or more additional external or internal devices, such as, without limitation, a secondary data storage element, such as database 240.

In one instance, processors 208 and 211 are manufactured by Intel Corporation, of Santa Clara, Calif. In other instances, other microprocessors are used.

The plurality of client devices 110 and the server 130 include instructions for a customized application selectively disabling functionality of a device. In one embodiment, the plurality of computer-readable medium 209 and 212 contain, in part, the customized application. Additionally, the plurality of client devices 110 and the server 130 are configured to receive and transmit electronic messages for use with the customized application. Similarly, the network 120 is configured to transmit electronic messages for use with the customized application.

One or more user applications are stored in memories 209, in memory 211, or a single user application is stored in part in one memory 209 and in part in memory 211. In one instance, a stored user application, regardless of storage location, is made customizable based on selectively disabling functionality of a device as determined using embodiments described below.

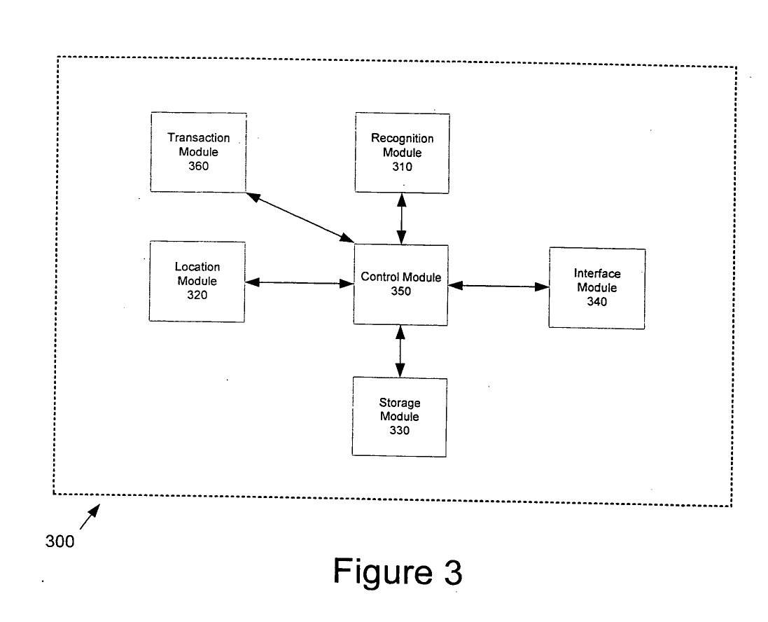

FIG. 3 illustrates one embodiment of a system 300. In one embodiment, the system 300 is embodied within the server 130. In another embodiment, the system 300 is embodied within the electronic device 110. In yet another embodiment, the system 300 is embodied within both the electronic device 110 and the server 130.

In one embodiment, the system 300 includes a recognition module 310, a location module 320, a storage module 330, an interface module 340, a control module 350, and a transaction module 360.

In one embodiment, the control module 350 communicates with the recognition module 310, the location module 320, the storage module 330, the interface module 340, and the transaction module 360. In one embodiment, the control module 350 coordinates tasks, requests, and communications between the recognition module 310, the location module 320, the storage module 330, the interface module 340, and the transaction module 360.

In one embodiment, the recognition module 310 determines the type of device that is detected. For example, the different types of devices include cellular phones, pagers, portable audio devices, still cameras, video cameras, and the like.

In one embodiment, the recognition module 310 senses the type of device by sensing the type of signal that is transmitted by the device. In another embodiment, the recognition module 310 senses the type of device by transmitting a signal to the device and receiving a confirmation from the device.

In one embodiment, the location module 320 detects the location of a device. In one embodiment, the location module 320 detects whether the device is within a predefined area. For example, the predefined area includes the viewing room within a movie theater. In another example, the predefined area includes the emergency room in a hospital.

In one embodiment, the location module 320 includes multiple sensors to detect the location of the device. In another embodiment, the location module 320 utilizes a cellular network to detect the location of the device.

In one embodiment, the storage module 330 stores a record including a profile for specifying the types of devices to be disabled, the functions to be disabled, and the areas that are affected.

In one embodiment, the interface module 340 receives a signal from one of the electronic devices 110. For example, in one instance, the electronic device transmits a signal identifying the device's type. In another embodiment, the interface module 340 transmits a signal to disable a device. In yet another embodiment, the interface module 340 displays information contained within the record associated with the profile.

In one embodiment, the transaction module 360 manages the selective disablement of devices based on authorization of payment from the devices. In one embodiment, the transaction module 360 requests payment from devices in exchange for allowing the devices to operate within a specific area. For example, the transaction module 360 requests payment from a camera device within an amusement park in exchange for allowing the camera device to capture photographs within the amusement park.

The system 300 in FIG. 3 is shown for exemplary purposes and is merely one embodiment of the methods and apparatuses for selectively disabling functionality of a device. Additional modules may be added to the system 300 without departing from the scope of the methods and apparatuses for selectively disabling functionality of a device. Similarly, modules may be combined or deleted without departing from the scope of the methods and apparatuses for selectively disabling functionality of a device.

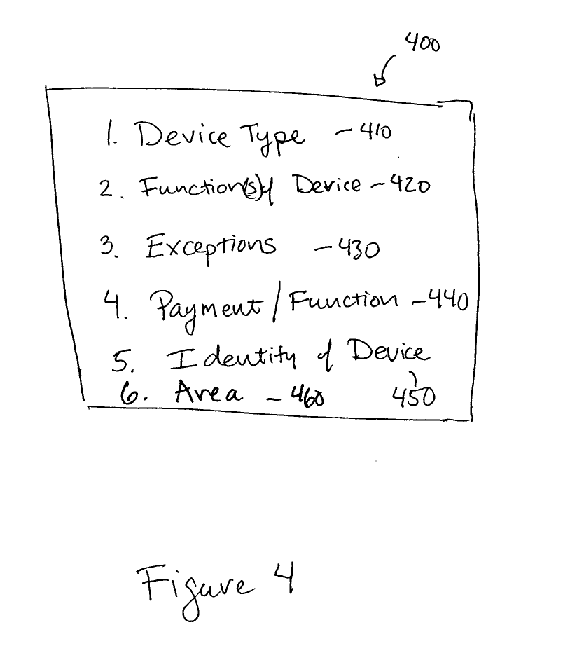

FIG. 4 illustrates an exemplary record 400 for use with the system 300. The record 400 is associated with a specific profile for selectively disabling functionality of a device. Parameters that comprise a specific profile are described by the record 400. In one embodiment, the record 400 includes a device type field 410, a device function field 420, an exceptions field 430, a payment field 440, an identity field 450, and a coverage area field 460.

In one embodiment, the device type field 410 indicates a type of device that is applicable for the specific profile as described by the record 400. In one embodiment, different types of devices include cellular phones, pagers, portable audio devices, still cameras, video cameras, and the like. In one instance, the specific profile specifies image capturing devices within the device type field 410. In this instance, only devices which fall under image capturing devices are affected by the specific profile.

In one embodiment, the device function field 420 indicates a function of a device that is applicable for the specific profile as described by the record 400. In one embodiment, the different functions include talking on a cellular phone, receiving a page, capturing an image, viewing through a viewfinder, listening to music, and the like.

In one embodiment, the exceptions field 430 indicates an exception that permits specific devices to be utilized for the specific profile as described by the record 400. In one embodiment, according to the exceptions field 430, a device having a characteristic is permitted for a specific profile according to the record 400. For example, the exceptions field 430 includes devices which are utilized by emergency services such as the police department. In this example, devices that are operated by the police department are allowed to continue functioning regardless of the restrictions on device functionality as described within the record 400.

In one embodiment, the payment field 440 indicates the amount of payment that is applicable for the specific profile as described by the record 400. In one embodiment, the payment field 440 includes the amount of payment that is needed for a specific function to operate. For example, a payment of $1.00 is requested to allow an image capturing device to operate within an amusement park for a 24 hour duration.

In another embodiment, some functions are not allowed regardless of payment. For example, cellular phone devices are not permitted to operate within a viewing area of a movie theater and operation of cellular phone devices are not able to be purchased.

In one embodiment, the identity field 450 indicates the identity of a particular device that is applicable for the specific profile as described by the record 400. In one embodiment, the identity of the device is determined by a serial number of the device. In another embodiment, the identity of the device is determined by a unique identifier of each device.

In one embodiment, the area field 460 indicates an area that is applicable for the specific profile as described by the record 400. In one embodiment, the area field 460 describes the parameters of the area that is applicable to the specific profile. In one instance, the area field 460 utilizes geographical coordinates such as degrees and minutes to describe the applicable area. In another instance, the area field 460 identifies the particular sensors that cover the applicable area.

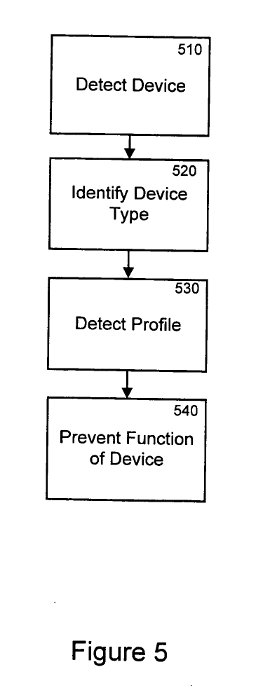

The flow diagrams as depicted in FIGS. 5, 6, and 7 are one embodiment of the methods and apparatuses for selectively disabling functionality of a device. The blocks within the flow diagrams can be performed in a different sequence without departing from the spirit of the methods and apparatuses for selectively disabling functionality of a device. Further, blocks can be deleted, added, or combined without departing from the spirit of the methods and apparatuses for selectively disabling functionality of a device.

The flow diagram in FIG. 5 illustrates selectively disabling functionality of a device according to one embodiment of the invention. In Block 510, an electronic device is detected. In one embodiment, the electronic device is a digital camera, a video camera, a personal digital device with an image capture module, a cellular phone, a pager, a portable audio device, and the like.

In Block 520, the device type of the electronic device is detected. In one embodiment, different types of devices include cellular phones, pagers, portable audio devices, still cameras, video cameras, and the like.

In Block 530, a profile is detected. In one embodiment, the profile corresponds with the area that the device is detected in the Block 510. For example, the area field 460 identifies the area that corresponds with a specific profile.

In one embodiment, the profile includes the device type field 410, the function field 420, and an exception field 430. In one embodiment, the device type field 410 is compared with the device type as detected in the Block 520. If the device type detected in the Block 520 matches the device type field 410 and the exceptions as listed in the exception field 430 does not apply to the device, then the device detected in the Block 510 is prevented from operating in the Block 540.

In Block 540, the device as detected in the Block 510 is prevented from operating specific functions. In one embodiment, the function field 420 specifies which functions are prevented from being utilized by the device.

In one instance, the device is any consumer electronic device on board an airplane having a goal to prevent devices from interfering with the airplane equipment. In this example, the consumer electronic devices are not allowed to remain turned on.

In another instance, the device is a cellular phone within a movie theater viewing area having a goal to prevent cellular phones from interfering with others viewing a movie. In this example, the cellular phone is allowed to remain turned on. However, in one embodiment, the ringer is disabled and a conversation is prevented.

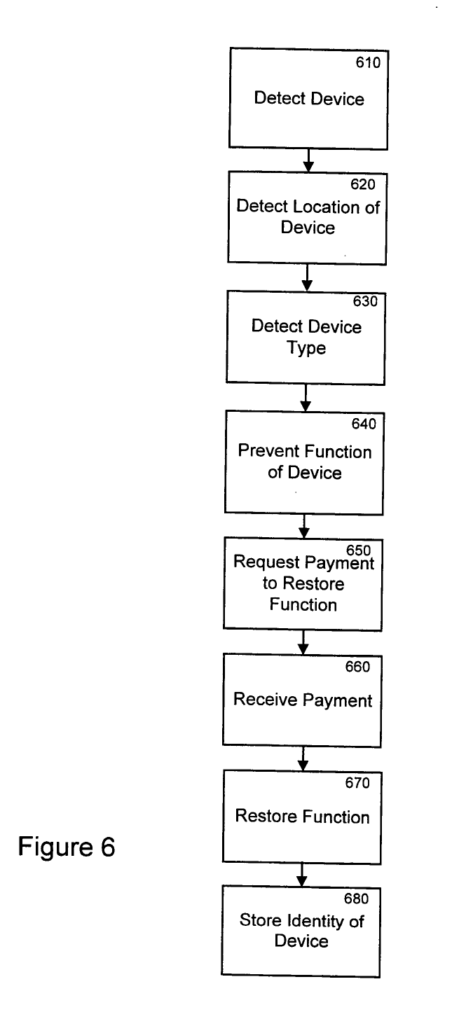

The flow diagram in FIG. 6 illustrates selectively disabling functionality of a device according to one embodiment of the invention. In Block 610, an electronic device is detected. In one embodiment, the electronic device is a digital camera, a video camera, a personal digital device with an image capture module, a cellular phone, a pager, a portable audio device, and the like.

In Block 620, a location of the detected device is determined. In one embodiment, the location is determined through at least one sensor. In another embodiment, the location is determined through the location module 320.

In Block 630, the device type of the electronic device is detected. In one embodiment, different types of devices include cellular phones, pagers, portable audio devices, still cameras, video cameras, and the like.

In Block 640, the device as detected in the Block 610 is prevented from operating specific functions. In one embodiment, the function field 420 specifies which functions are prevented from being utilized by the device. In one embodiment, the device is prevented from operating based on the location of the device and the device type.

In Block 650, a request for payment to restore functionality is transmitted to the device. In one embodiment, the payment field 440 determines whether making a payment to restore operability of the device is available. In another embodiment, the payment field 440 determines the amount to request.

In one embodiment, the request for payment is transmitted via the transaction module 360. For example, in one instance, the transaction module 360 detects the payment field 440 and transmits the request for payment to the device.

In Block 660, the payment is received from the device. In one embodiment, the payment is a credit card authorization. In another embodiment, the payment is in the form of a micro-payment.

In Block 670, the function that was disabled in the Block 640 is restored based on receipt of the payment in the Block 660.

In Block 680, the identity of the device is stored in association with the payment received from the device in the Block 660.

For example, in one instance, the device is detected within the Block 610. The device is detected within a location of a stadium during a concert event within the Block 620. In the Block 630, the device is detected as an image capturing device such as a camera. According to the profile, the image capturing device is disabled from capturing images in the Block 640. In the Block 650, a request for payment is transmitted to the device if the user of the device wishes to capture images. In the Block 660, the payment from the device is received. In the Block 670, the image capturing device is able to capture images within the stadium during the concert. In the Block 680, the identity of the image capturing device is stored such that during the concert, the particular image capturing device is recognized and allowed to capture images without further action.

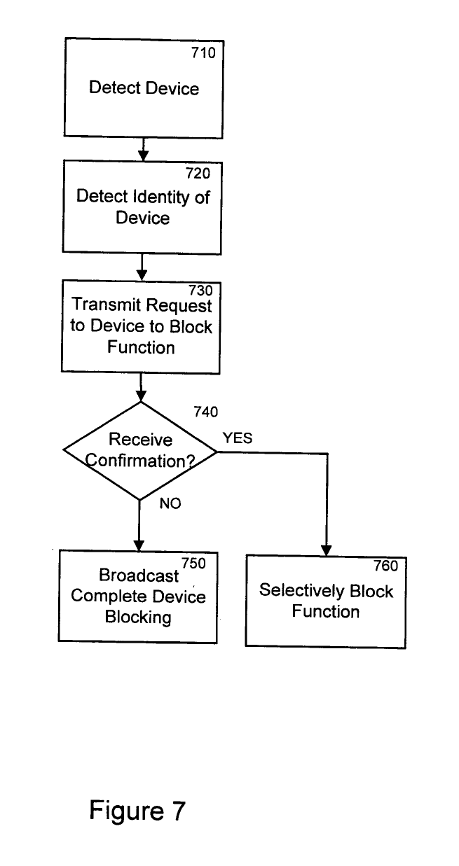

The flow diagram in FIG. 7 illustrates selectively disabling functionality of a device according to one embodiment of the invention. In Block 710, an electronic device is detected. In one embodiment, the electronic device is a digital camera, a video camera, a personal digital device with an image capture module, a cellular phone, a pager, a portable audio device, and the like.

In Block 720, an identity of the device is detected. In one embodiment, the identity of the device is a serial number assigned to the device. In another embodiment, the identity of the device is a unique identifier.

In Block 730, a request to disable a particular function on the device is transmitted to the device. In one embodiment, the particular function is chosen through the profile associated with a particular record 400. For example, in one instance, the device is a pager. In this example, the function of the pager to be disabled is any audible notification from the pager. However, a silent notification from the pager such as a vibrating notification is allowable. Further, with the audible notification disabled, the pager is able to continue receiving incoming pages and is able to utilize the silent notification to indicate an incoming page.

In Block 740, a confirmation that the particular function of the device is disabled detected. In one embodiment, the device transmits the confirmation.

If there is a confirmation from the device, then the particular function of the device is selectively disabled in Block 760.

If a confirmation is not received from the device, then an indiscriminate disablement of the device is utilized in the Block 750. In one embodiment, a jamming signal is utilized to completely disable the device.

For example, in one instance, the device is a cellular phone located within a movie theater. In this example, if the cellular phone transmits a confirmation that an audible alert and the ability to carry a conversation is disabled, then the cellular phone is able to receive calls and utilize a silent notification. However, if the confirmation is not received, the cellular phone will be completely disabled and not able to receive any calls.

The foregoing descriptions of specific embodiments of the invention have been presented for purposes of illustration and description. The invention may be applied to a variety of other applications.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A method comprising:
detecting a device;
detecting a device type of the device; and
transmitting a signal to the device for selectively disabling a function of the device based on the device type.

2. The method according to claim 1 further comprising detecting a location of the device.

3. The method according to claim 2 wherein disabling the function is based on the location of the device.

4. The method according to claim 1 further comprising detecting a profile containing a device type field and a function field.

5. The method according to claim 4 further comprising storing the profile with a storage module.

6. The method according to claim 1 wherein the function is producing an audible alert.

7. The method according to claim 1 wherein the function is emitting an audible sound from the device.

8. The method according to claim 1 wherein the function is capturing an image with the device.

9. The method according to claim 1 wherein the device is a camera.

10. The method according to claim 1 wherein the device is a cellular phone.

12. The method according to claim 1 wherein the device is a portable music device.

13. The method according to claim 1 wherein the device is a video camera.

14. A system comprising:
means for detecting a device;
means for detecting a device type of the device; and
means for transmitting a signal to the device for selectively disabling a function of the device based on the device type.

15. A method comprising:
detecting a device;
detecting a location of the device;
detecting a device type of the device; and
selectively disabling a function of the device based on the location and the device type.

16. The method according to claim 15 further comprising requesting a payment from the device for restoring the function.

17. The method according to claim 16 further comprising restoring the function of the device in exchange for the payment.

18. The method according to claim 15 further comprising recalling a profile including an area field, a device type field, and a function field for disabling the function of the device.

19. The method according to claim 15 wherein the device type is an image capturing device.

20. The method according to claim 15 wherein the device type is a cellular phone device.

21. The method according to claim 15 wherein disabling the function turns the device off.

22. The method according to claim 15 wherein disabling the function prevents the device from emitting sound.

23. The method according to claim 15 wherein disabling the function prevents the device from capturing an image.

24. A system, comprising:
a recognition module for detecting a device and a device type of the device;
a location module for detecting a location of the device; and
a storage module configured for storing a profile that selectively disables a function of the device based on the device type and the location of the device.

25. The system according to claim 24 further comprising a transaction module configured to handle a payment request in exchange for restoring the function of the device.

26. The system according to claim 24 wherein the recognition module further comprises detecting an identity of the device.

27. The system according to claim 24 further comprising an interface module for communicating with the device.

28. A computer-readable medium having computer executable instructions for performing a method comprising:
detecting a device;
detecting a location of the device;
detecting a device type of the device; and
selectively disabling a function of the device based on the location and the device type.
